(19) United States
(12) Patent Application Publication
(10) Pub. No.: US 2024/0054034 A1
(43) Pub. Date: Feb. 15, 2024

(54) CAPABILITY PROXY FOR SEMANTIC FUNCTION DISCOVERY AND PROVISIONING OF APPLICATION-REQUESTED CAPABILITIES

(71) Applicant: Microsoft Technology Licensing, LLC, Redmond, WA (US)

(72) Inventors: Haishi BAI, Carnation, WA (US); Boris Markus SCHOLL, Gauting (DE)

(21) Appl. No.: 18/146,525

(22) Filed: Dec. 27, 2022

Related U.S. Application Data
(60) Provisional application No. 63/397,943, filed on Aug. 15, 2022.

(51) Int. Cl. G06F 9/54

(52) U.S. Cl. CPC G06F 9/547

(57) ABSTRACT

A computing system includes a capability proxy that receives a semantic description of a requested function capability; determines an execution constraint associated with the requested function capability; queries a function registry based at least in part on the requested function capability; and identifies, based on information returned from the function registry, a select function that provides the requested function capability and that has an execution characteristic satisfying the execution constrain. The capability proxy executes the select function and returns an output of the select function.

### CROSS-REFERENCE TO RELATED APPLICATIONS

The present application claims priority to U.S. provisional application Ser. No. 63/397,943, entitled “Capability Proxy for Semantic Function Discovery and Provisioning of Application-Requested Capabilities” and filed on Aug. 15, 2022, which is hereby incorporated by reference for all that it discloses or teaches.

### BACKGROUND

When programming an application to perform a given task, a developer may devote significant time manually searching for available functions capable of performing the task. For example, a developer may review semantic descriptions of functions indexed within various local and/or web-based registries in an effort to identify function(s) that offer a desired capability. With the growing availability of Software as a Service (SaaS) products, developers are faced with more options than ever before.

### SUMMARY

In one implementation, a method provides for executing a capability proxy to provide an application with a requested function capability. The method includes receiving, from the application, a semantic description of the requested function capability; determining an execution constraint associated with the requested function capability; querying a function registry based at least in part on the requested function capability; and identifying, based on information returned from the function registry, a select function that provides the requested function capability and that has an execution characteristic satisfying the execution constraint. The method further includes executing the select function on behalf of the application and returning an output of the select function to the application.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein

### BRIEF DESCRIPTION OF THE DRAWINGS

FIG. 1 illustrates aspects of an example system including a capability proxy that discovers and executes functions on behalf of an application.

FIG. 2 illustrates an example capability oriented architecture including a capability proxy that receives a semantic description that includes a function capability and that performs actions to provide the function capability to the client.

FIG. 3 illustrates an example network environment a capability proxy offered as a web-hosted service.

FIG. 4 illustrates example operations of a capability proxy to serve an application with a requested function capability.

FIG. 5 illustrates an example schematic of a processing device suitable for implementing aspects of the disclosed technology.

### DETAILED DESCRIPTION

The herein disclosed technology provides a capability-oriented architecture and programming model that leverages an artificial intelligence (AI) tool, referred to herein as a “capability proxy,” that identifies, selects, and executes a function to provide an application with a capability that fulfills a developer's intent. According to one implementation, the capability proxy interfaces with an application and receives, from the application, a developer-provided semantic description of a desired function capability. As used herein, a “function capability” refers to a task, or multiple tasks, that are accomplished by executing a given function to fulfill a developer's intent. For example, the task may be translating English to Mandarin, automatically unlocking doors in a vehicle, or analyzing an image to identify a number of persons present in the image.

In one implementation, a developer coding an application includes, within the application's source code, a call to a capability proxy that includes a semantic description of a desired function capability (e.g., the developer's intent) rather than a call to a specific function that provides the desired capability. For example, the semantic instruction may include human-readable language such as: “Do process [X]” or “Turn on AC” that is passed to a capability proxy. The developer may also specify one or more execution constraints within the semantic description and/or in a configuration file for the application. As used herein, an “execution constraint” refers to queryable characteristics of the function or the function provider, such as a characteristics relating to service provider type (e.g., local, cloud-based function provider, cloud-based container provider), a constraint specifying a desired quality of service (e.g., minimize latency, processing cost, or power consumption), a constraint pertaining to accuracy of the candidate function (e.g., select only functions that guarantee output accuracy within 2 sigma), and/or a constraint relating to one or more vendor qualifications. For example, the developer may include a semantic description “process [X batch of data] using lowest-cost method.” This specifies a function capability (e.g., processing [X batch of data]) and further specifies an execution constraint (e.g., a preference for selecting the lowest cost processing method identified).

Using the received semantic description of the function capability, the capability proxy discovers one or more available functions that provide the function capability—meaning, the function(s) can be executed to perform the task(s) of interest. According to one implementation, the capability proxy searches one or more function registries to identify suitable candidate functions that provide capabilities matching a function capability included in a semantic description that the capability proxy receives from an application. In the event that multiple suitable candidate functions are identified, the capability proxy may utilize the developer-specified execution constraints to select between the available candidate functions.

Upon selecting a “best match” function of the identified candidates, the capability proxy may discover actions to acquire the capability (also referred to herein as actions to consume the capability) which may, for example, include actions such as discovering a URL where the requested function is provided as a service, negotiating a contract to with an endpoint, utilizing tool(s) to generate client-side code to execute the function, and/or launching containers and/or scripts to otherwise access or create a runtime environment for the identified function.

Once the runtime environment is created or otherwise made accessible, the capability proxy constructs and executes an API call within the runtime environment to execute the selected function. Outputs of the function are returned to the application.

The foregoing technology significantly lessens software development burdens related to identifying and executing suitable functions by automating the function discovery process and the function execution process such that an application can receive a function result without being encoded with an appropriate API call to a specific function and, in some cases, without developer-performed configuration actions (e.g., for obtaining a runtime environment) that would otherwise have to be performed to serve an application with a desired function capability.

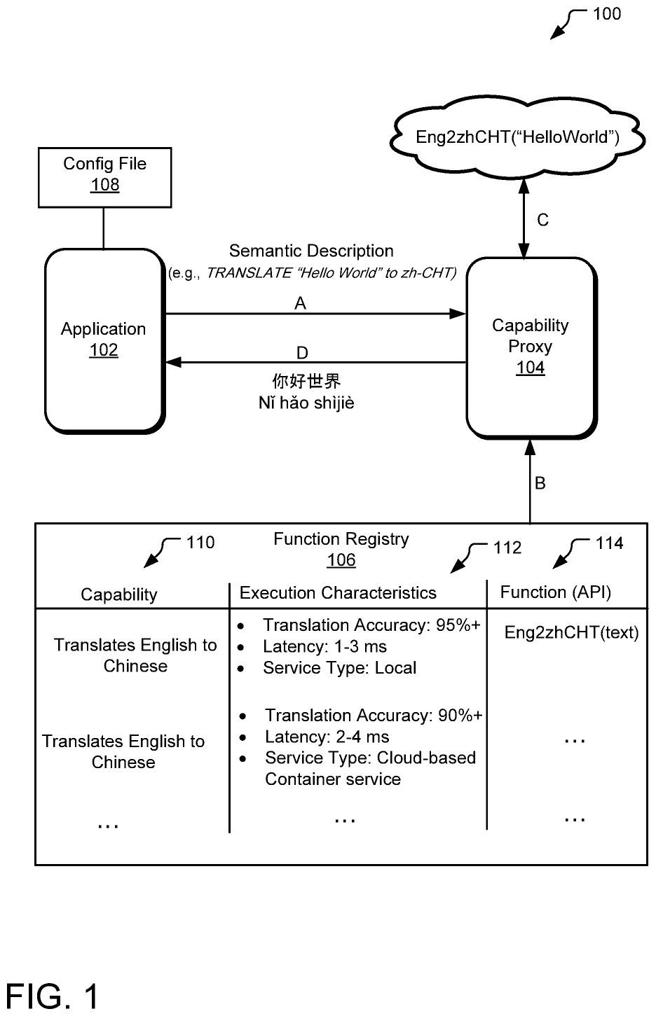

FIG. 1 illustrates aspects of an example system 100 including a capability proxy 104 that discovers and executes functions on behalf of an application 102. The application 102 is an executable body of code designed to run on a variety of different platforms and serve any of a number of different purposes. When drafting the code of the application 102, a developer may prepare or otherwise obtain a config file 108 that stores information about the libraries, modules, and packages used while developing the application.

Before the application 102 is executed, the config file 108 is used to create a suitable runtime environment. For example, the config file 108 may be provided to an application that installs the dependencies defined in the config to generate the execution runtime environment. For example, the Unix operating system accepts a text file titled “requirements.txt” as an input to an install command that is executed to create a runtime environment for a particular source code. Likewise, other platforms may utilize various application(s) to create the runtime environment by installing dependencies identified in a developer-provided installation script. In other systems, the installation script may be an executable (as opposed to a text file) that can be executed create the execution runtime environment for the associated source code.

In one implementation, the config file 108 defines an address indicating a location of a function registry 106 that is to be accessed by the capability proxy 104 in carrying out various tasks on behalf of the application 102. The function registry 106 is, for example, a public registry in which various developers register functions and associated information. Depending on the implementation, the function registry may be defined at an enterprise level (e.g., the same registry used for all developers of an enterprise) or at a higher, global level (e.g., a provider of the capability proxy 104 provides a globally-accessible function registry that can be accessed by developers of many different enterprises utilizing the capability proxy 104).

In general, the function registry 106 includes information defining capabilities of various functions and execution characteristics of each function. In the example of FIG. 1, the function registry 106 includes, for each registered function, a semantic description of the function capability in a searchable capability index 110 and a semantic description of the execution characteristics 112 of the function. As used herein, an “execution characteristic” refers to a characteristic of a function that describes an attribute of the function or function request that is different from the capabilities (e.g., utility) that the function provides. For example, an execution characteristic may specify a provider type for the function (e.g., local, local-based function provider, a cloud-based container service, a quality of service metric characterizing function output (e.g., a latency metric, processing cost metric, power consumption metric), accuracy of the outputs(s) provided by the function, or a vendor qualification of the function provider. In addition to including the semantic descriptions of function capability and execution characteristic(s) for each registered function, the function registry 106 also includes API construct information 114 detailing how the function can be invoked (e.g., how to build a call using its syntax).

Although not shown, the function registry 106 may further include “capability acquisition information”—a term used herein to refer to information that is usable to teach the capability proxy 104 how to consume the desired capability (e.g., actions that the capability proxy 104 may perform to create or access a runtime environment for executing a registered function). The capability acquisition information indicates how the function is invoked (e.g., a call to a service endpoint, service discovery endpoint, web service description, or through an agent that downloads and executes a service instance). For example, the capability acquisition information may include information on how to connect to a remote service, download and launch a Docker container instance, or delegate calls to a peer device on the same network.

The capability proxy 104 is, in one implementation, an executable that incorporates artificial intelligence (AI) for natural language processing to discover functions with capabilities requested by the application 102. In other implementations, the capability proxy 104 does not utilize AI and instead relies on matching rules or other (e.g., hardcoded) logic. The capability proxy 104 accesses and searches the function registry 106 to identify functions with requested capabilities and manages all details of invoking such functions to perform tasks requested by the application 102 on behalf of the application 102.

In one implementation, the config file 108 defines the capability proxy 104 within a library accessible by the application 102. In another implementation, the capability proxy 104 is hosted by a separate container running on the same machine as the application 102. For example, the application 102 may call the capability proxy 104 by making a hypertext transfer protocol (HTTP) or a remote procedure call (RPC) request into the separate container that carries out the requested tasks. In yet still further implementations, the capability proxy 104 is a callable service, such as a service that resides on one machine of a cluster of networked machines subscribed to the service.

Once the config file 108 is used to create the runtime environment for the application 102, source code of the application 102 can be compiled without error into an executable binary. The source code of the application 102 includes one or more lines of human-readable semantic description requesting a particular task. Each different one of these human-readable task requests is referred to herein as a “proxy call” because it is handled by the capability proxy 104. For example, a proxy call may look like a function call (e.g., to the proxy, with inputs including a semantic description such as: “turn on the air conditioning in [VehicleID]” or “do process [X] batch of data”). The proxy call does not include an API call or otherwise identify a known function or interface capable of handling the task specified within the semantic description, and a developer drafting the proxy call also many not know of a function that provides the requested function capability.

During execution of the application 102, each proxy call is passed to the capability proxy 104, and the capability proxy 104 performs actions on behalf of the application 102 that include (1) searching for a function with the requested capability; (2) once identified, acquiring the capability to execute the function (e.g., such as by performing actions to construct or acquire the function's requisite runtime environment); (3) constructing a call to the function; (4) executing the function on behalf of the application 102; and (5) returning the function output to the application 102.

Upon receiving a proxy call, the capability proxy 104 accesses the function registry 106 and begins searching for a function with a capability matching the requested capability included within the received semantic description. In the example shown in FIG. 1, the body of the application 102 includes a proxy call “Translate ‘Hello World’ to zh-CHT.” Here, zh-CHT is the well-known symbol for traditional Chinese. Upon receiving this semantic description (as indicated by arrow “A” in FIG. 1), the capability proxy 104 searches the capability index 110 in the function registry 106 to look for a function with the capability of translating English to Chinese (e.g., as indicated by arrow “B” in FIG. 1). In the illustrated example, the capability proxy identifies at least two functions—referred to herein as “candidate functions”—that provide the requested capability.

To select between the identified candidate functions that provide the requested capability, the capability proxy 104 first determines whether or not any execution constraints have been specified in relation to the proxy call, such as within the semantic description that sets forth the requested capability. For example, the proxy call may read: “Translate ‘Hello World’ to zh-CHT using lowest cost method” (where “lowest cost method” indicates an execution constraint). In other implementations, the developer may specify execution constraints in the config file 108 for the application. For example, the config file 108 may set a preference for using local functions over cloud-based functions when both are available to provide a requested capability. In some implementations, some or all execution constraints for function selection are set at the enterprise-level, such as when an enterprise sets configurable settings of the capability proxy 104. For example, an enterprise may configure the capability proxy 104 to prioritize selection of functions that are locally available over functions that are cloud-based. In this case, all developers of the enterprise call upon an instance of the capability proxy 104 configured according to the enterprise's configuration settings, imposing the execution constraint to select locally-executable functions when available.

After identifying one or more developer or enterprise-specified execution constraints that apply to the requested capability, the capability proxy determines which (if any) of the identified candidate functions are characterized by execution characteristic(s) 112 that satisfy the identified execution constraint(s). Assume, for example, that config file 108 includes an execution constraint specifying a policy for selecting local functions over cloud-based functions when both are available to provide a requested capability. In this case, the capability proxy 104 analyzes the execution characteristics 112 of candidate functions within the function registry 106 and determines that the first of these two candidate functions is locally-available while the second one is a cloud-based container service. Based on the developer-specified execution constraint being satisfied by the execution characteristic of the first of these two candidate functions, the capability proxy 104 selects the first candidate function and uses the associated API construct information 114 in the function registry to construct and place an API call to invoke the selected function behalf of the application (as indicated by arrow C). The capability proxy 104 receives a result from the selected function and returns the function result to the application 102 (as indicated by arrow D).

When selecting between multiple identified candidate functions (e.g., a group of functions that each individually provide a same requested capability), the capability proxy 104 seeks to identify a select one of the candidate functions with a set of execution characteristics that satisfies—or most closely satisfies—the set of execution constraints that the developer has specified in association with the function capability request. If, for example, the semantic description sets forth three different execution constraints and none of the candidate functions have execution characteristics satisfying all three execution constraints, the capability proxy may select a candidate function with execution characteristics satisfying two of the three constraints over another candidate function with execution characteristics satisfying a single one of the execution constraints.

Likewise, if two or more candidate functions have execution characteristics satisfying the developer-specified execution constraint(s), the capability proxy 104 may implement AI logic to select a best fit match. If, for example, an execution constraint requests a function accuracy of greater than 95% and multiple candidate functions promise this result, the capability proxy 104 may select the candidate function that offers the highest accuracy rate. In other implementations, the capability proxy 104 may implement other hard-coded rules or human-configurable policies for selecting between multiple candidate functions that satisfy the developer-specified execution constraints.

In some implementations, the various proxy calls within the source of the application 102 set forth one or more developer-specified policies effectively shaping how a function may be called or carried out after being selected. For example, the proxy call may set forth a policy that effectively instructs the capability proxy 104 to cache results of the selected function, and/or a “retry” policy that governs how the capability proxy 104 is to manage errors (e.g., “retry up to 5 times at 2 second intervals and if still unsuccessful, invoke secondary candidate function”). In these cases, the capability proxy 104 executes the selected candidate function in a manner consistent with the developer-specified polic(ies).

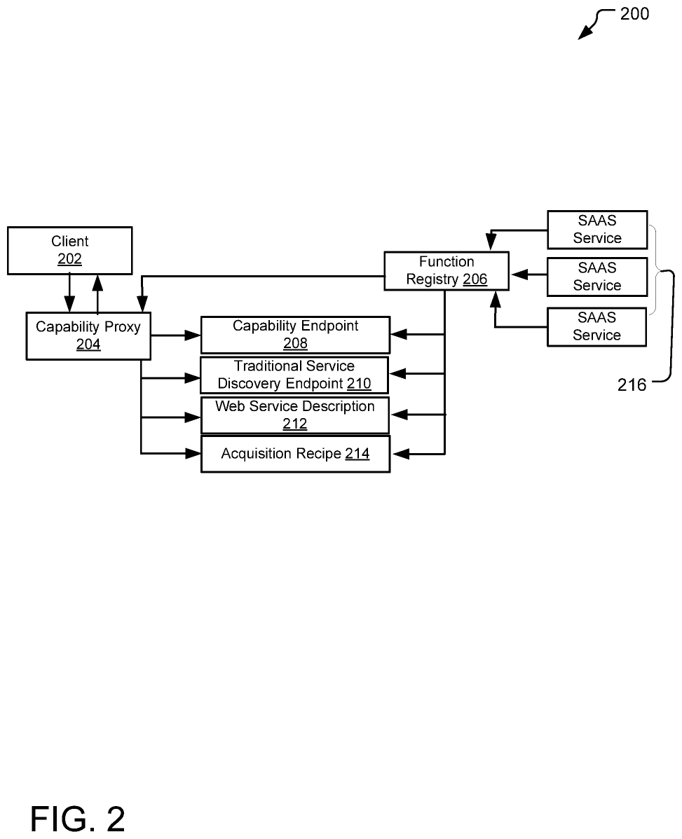

FIG. 2 illustrates an example capability oriented architecture 200 that includes a capability proxy 204 that receives a semantic description from a client 202 (e.g., an application) during execution of the client 202. The semantic description specifies a desired function capability. The capability proxy 204 performs actions for discovering candidate functions that provide the requested function capability as well as action(s) for acquiring the ability to execute the function (as applicable), and actions to invoke the function and return the result to the client 202.

According to one implementation, the client 202 provides the capability proxy 204 with a semantic description identifying a function capability, such as in a manner the same or similar to that described above with respect to FIG. 1. The capability proxy 204 determines applicable execution constraints specified in association with a proxy call in the client 202 (e.g., a call in the client application that includes the semantic description). For example, execution constraints may be specified within the semantic description, within a configuration file (not shown) of the client 202, or by configurable setting of the capability proxy 204 such as a setting configured by an enterprise that makes an instance of the capability proxy 204 available to its developers.

Upon receipt of the semantic description specifying the desired function capability, the capability proxy 204 queries a function registry 206 for functions that have a semantic description matching the semantic description of the desired capability and that have execution characteristic(s) satisfying the identified execution constraint(s). The function registry 206 is, for example, a publicly-accessible registry that includes descriptions of functions registered by multiple different SAAS service providers 216. The location of the function registry 206 may be globally-defined, such as by a provider of the capability proxy 204, or instead locally-defined such as per a configuration setting of the capability proxy 204 or a local variable defined in a configuration file of the client 202.

For each semantic description received at the capability proxy 204 from the client 202, the capability proxy 204 queries the function registry 206 to identify candidate functions that provide the associated requested function capability and that satisfy identified applicable execution constraints. In one implementation, the capability proxy uses a hard-coded and/or configurable strategy to select a function from multiple identified candidate functions that provide the requested capability. For example, an enterprise using the capability proxy 204 may set various configurable settings to implement rules for prioritizing functions that offer certain types of execution characteristics, such as by selecting functions that mitigate cost, offer highest accuracy, lowest latency, lowest power consumption, or that are offered by trusted vendors (e.g., vendors listed on a curated capability vendor list of the enterprise). Likewise, the developer of the client 202 may specify desired execution constraints in addition to or in lieu of enterprise-specified execution constraints (e.g., to override constraints set by the enterprise).

Upon selecting a candidate function from the function registry 206, the capability proxy 204 retrieves capability acquisition information from the registry, as applicable. In some implementations, the retrieved capability acquisition information identifies a type of endpoint that provides the selected candidate function as a service and/or further identifies one or more capability consumption actions for creating or accessing a suitable runtime environment for the selected function.

For some functions registered in the function registry 206, the associated capability acquisition information may identify a capability endpoint 208, which is a service endpoint providing a capability oriented architecture API that defines callable routes (e.g., a registry of sorts). In such cases, the capability proxy 204 may query the capability endpoint 208 to determine an appropriate route usable to invoke the function of interest. For example, the capability endpoint 208 may be an HTTP endpoint. The HTTP endpoint is directly consumable in the sense that the capability proxy 204 knows how to communicate with the HTTP endpoint querying the function registry 206 without performing any additional steps after. If, for example, the capability of interest is “face detection,” the capability proxy 204 may retrieve an HTTP endpoint from the service registry that performs a face detection function as a service. In this scenario, the function registry 206 includes all information that the capability proxy 204 needs to be able to invoke an API call to instruct the http endpoint to perform the function (e.g., passing the applicable parameters to the function).

For other functions registered in the function registry 206, the requested capability may not be directly consumable from the information in the function registry 206. In these cases, the capability proxy 204 performs additional actions to learn how to invoke the function. For example, the function registry 206 may, in some cases, identify a traditional service discovery endpoint 210 that the capability proxy 204 in turn communicates in order to discover an actual service endpoint providing a function with the characteristics of interest. For example, the capability proxy 204 retrieves, from the function registry 206, a discovery endpoint (a URL of another registry) that the capability proxy 204 communicates with to perform a “second” discovery. For example, the secondary discovery discovers a service endpoint that the capability proxy 204 in turn accesses to learn how to invoke the function of interest at the service endpoint.

For still other functions registered in the function registry 206, the associated capability acquisition information may include a service description, such as a Web Service Description Language (WSDL) document to instruct the client on how to consume the service. For example, the registry may return a WSDL artifact that indicates a particular tool that is usable to generate code to invoke the service of interest, and the capability proxy 204 uses the tool as instructed in the WSDL to generate the code to invoke the service of interest.

For still other functions registered in the function registry 206, the associated capability acquisition information includes an acquisition recipe 214 for acquiring an ability. For example, the acquisition recipe 214 may contain instructions to pull down a container image (e.g., a docker image) from a registry (e.g., a Docker registry) and to launch a local container (e.g., a local Docker container) to provide a service. Another example of the acquisition recipe 214 is a shell script that uses Linux's “package manager” to download and install binaries and to launch a new system service.

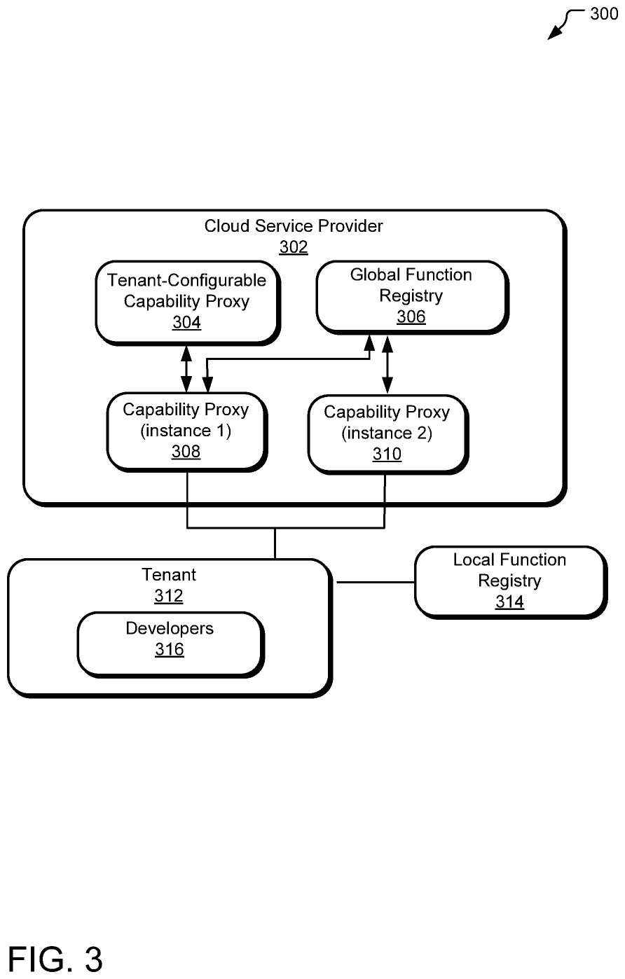

FIG. 3 illustrates an example network environment 300 including a capability proxy offered to tenants of a web-hosted service. The network environment 300 includes a cloud service provider 302 that offers a SAAS service including a tenant-configurable capability proxy 304. The tenant-configurable capability proxy 304 may be understood as having the same or similar characteristics as those described with respect to the capability proxy 104 of FIG. 1 and 204 of FIG. 2 except that it is “tenant-configurable” in the sense that each of multiple tenants (e.g., Tenant 312) to the cloud service provider 302 may configure select settings of the capability proxy and deploy one or more instance of the capability proxy according to those selected settings. A tenant is, for example, an enterprise that leases the resources provided by the cloud service provider 302.

By example, FIG. 3 shows the Tenant 312 as having configured two different capability proxy instances 308, 310 (e.g., executable instances of the tenant-configurable capability proxy 304). Each of these different capability proxy instances 308 and 310 is configured to auto-implement one or more policies and/or execution constraints defined by the tenant 312.

In one implementation, the tenant-configurable capability proxy 304 includes a configurable setting that allows the tenant 312 to designate a path for a default function registry and/or one or more secondary function registries. In the illustrated example, the tenant 312 maintains a local function registry 314 and the cloud service provider 302 maintains a global function registry 306, each of which includes function registry information the same or similar to that described above with respect to function registry 106 of FIG. 1. For example, the local function registry 314 is a registry of functions developed by the enterprise and/or available on servers hosted by the enterprise while the global function registry 306 includes functions that are offered by the cloud service provider 302 or other SAAS providers. Each of the local function registry 314 and the global function registry 306 defines a capability of each indexed function as well as one or more execution characteristics and acquisition information that indicates how the function is invoked.

In addition to the configurable setting designating a default function registry path, the capability proxy instances 308, 310 may be further configured, by the tenant 312, to implement various differing execution policies (e.g., caching policies, retry policies) and/or various execution constraints that are to be imposed each time the capability proxy is invoked by a client application. Various developers 316 of the tenant 312 may selectively invoke a specific one of the different capability proxy instances 308 or 310, depending upon the role and objective(s) of the developer.

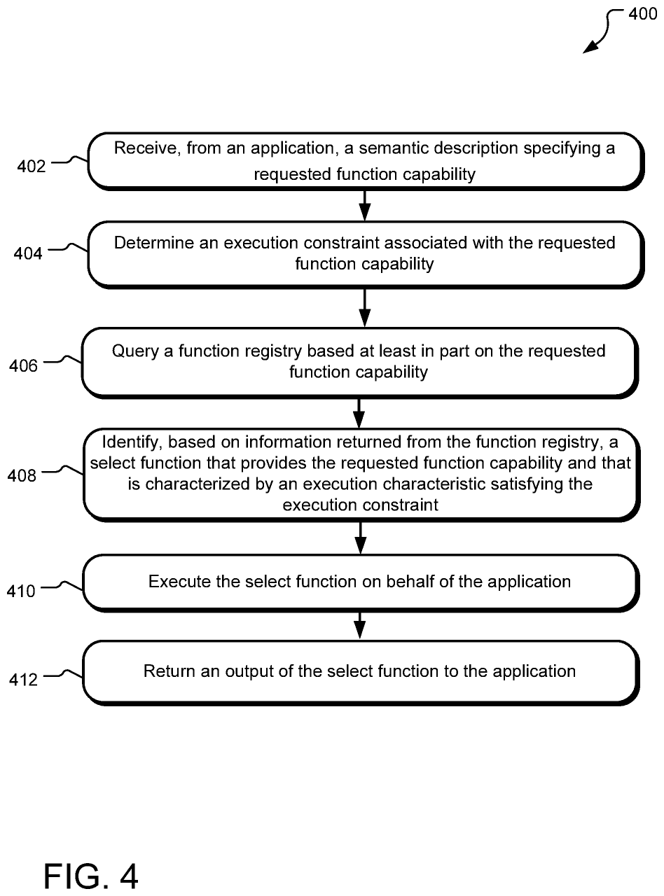

FIG. 4 illustrates example operations 400 performed by a capability proxy to serve an application with a desired function capability. A receiving operation 402 receives, from an application, a semantic description specifying a requested function capability. A determination operation 404 determines an execution constraint associated with the requested function capability. In various implementations, the execution constraint is included within the semantic description, specified in a configuration file of the application, or defined by an enterprise-configurable setting of the capability proxy.

A querying operation 406 queries a function registry based at least in part on the requested function capability (e.g., to search for a function in the registry that provides a capability matching the requested function capability).

An identification operation 408 identifies, based on information returned from the function registry, a select function that provides the requested function capability and that is characterized by an execution characteristic satisfying the execution constraint.

An execution operation 410 executes the select function on behalf of the application. In some implementations, the execution operation 410 entails retrieving capability acquisition information and performing actions for configuring or accessing a runtime environment in which the function can be compiled and executed. Example actions include those discussed with respect to the FIG. 2 (e.g., the capability endpoint 208, traditional service discovery endpoint 210, web service description 212, and acquisition recipe 214). Additionally, the execution operation 410 may entail constructing and executing an API call to invoke the function. A return operation 412 returns an output of the select function to the application.

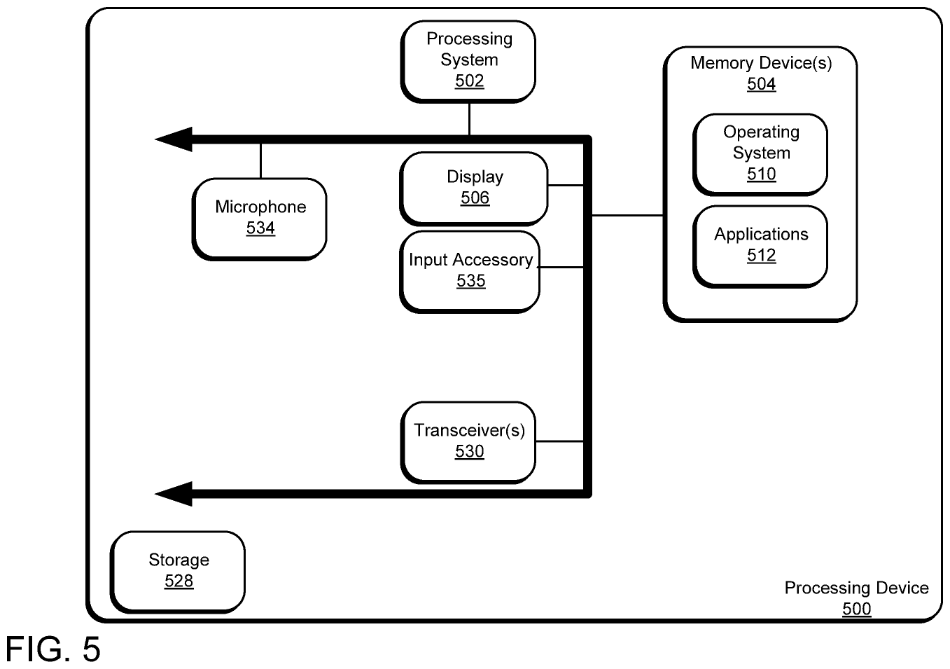

FIG. 5 illustrates an example schematic of a processing device 500 suitable for implementing aspects of the disclosed technology. The processing device 500 includes a processing system 502, memory device(s) 504, a display 506, and other interfaces 508 (e.g., buttons). The processing system 502 includes one or more processors (CPUs, GPUs, etc.). The memory 504 generally includes both volatile memory (e.g., RAM) and non-volatile memory (e.g., flash memory). An operating system 510 may reside in the memory 504 and be executed by the processing system 502.

One or more applications 512 (e.g., the capability proxy 104 and the application 102 of FIG. 1) are loaded in the memory 504 and executed on the operating system 510 by the processing system 502. The applications 512 may receive inputs from one another as well as from various input local devices such as a microphone 534, and an input accessory 535 (e.g., keypad, mouse, stylus, touchpad, gamepad, joystick). Additionally, the applications 512 may receive input from one or more remote devices, such as remotely-located smart devices, by communicating with such devices over a wired or wireless network using more communication transceivers 530 and an antenna 538 to provide network connectivity (e.g., a mobile phone network, Wi-Fi®, Bluetooth®). The processing device 500 may also include one or more storage devices 528 (e.g., non-volatile storage). Other configurations may also be employed. The processing device 500 further includes a power supply 516, which is powered by one or more batteries or other power sources and which provides power to other components of the processing device 500.

The processing device 500 may include a variety of tangible computer-readable storage media and intangible computer-readable communication signals. Tangible computer-readable storage can be embodied by any available media that can be accessed by the processing device 500 and includes both volatile and nonvolatile storage media, removable and non-removable storage media. Tangible computer-readable storage media excludes intangible and transitory communications signals and includes volatile and nonvolatile, removable and non-removable storage media implemented in any method or technology for storage of information such as computer readable instructions, data structures, program modules or other data. Tangible computer-readable storage media includes RAM, ROM, EEPROM, flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information, and which can be accessed by the processing device 500. In contrast to tangible computer-readable storage media, intangible computer-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, intangible communication signals include wired media such as a wired network or direct-wired connection, and wireless media such as acoustic, RF, infrared, and other wireless media.

Some implementations may comprise an article of manufacture. An article of manufacture may comprise a tangible storage medium (a memory device) to store logic. Examples of a storage medium include one or more types of processor-readable storage media capable of storing electronic data, including volatile memory or non-volatile memory, removable or non-removable memory, erasable or non-erasable memory, writeable or re-writeable memory, and so forth. Examples of the logic include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture stores executable computer program instructions that, when executed by a computer, cause the computer to perform methods and/or operations in accordance with the described implementations. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain operation segment. The instructions may be implemented using any suitable high-level, low-level, object-oriented, visual, compiled and/or interpreted programming language.

(A1) In an example method disclosed herein, an application is provided with a requested function capability. The method includes receiving, from the application, a semantic description of the requested function capability; determining an execution constraint associated with the requested function capability; querying a function registry based at least in part on the requested function capability; and identifying, based on information returned from the function registry, a select function that provides the requested function capability and that has an execution characteristic satisfying the execution constraint. The method further provides for executing the select function on behalf of the application and for returning, to the application, an output of the select function. The method of A1 is advantageous because it allows an application to be provided with a function capability even if the developer of the function is not aware of a specific function that provides the requested capability. The developer does not need to include the specific function all in the source code of the application.

(A2) In another example method of any preceding method (e.g., A1), each function of a plurality of functions include a semantic description of function capability and one or more execution characteristics. This is beneficial because it may allow the capability proxy to perform a natural language based search and/or employ matching rules to identify a function with a semantic description that best matches the function capability requested by the application.

(A3) In yet still another example method of any of the preceding methods (e.g., A1-A2), the function registry further includes an application programming interface (API) syntax usable to invoke each function included in the function registry. The capability proxy constructs a call to the select function using the API syntax that is specified in the function registry in association with the select function.

(A4) In yet still another example method of any of the preceding methods (e.g., A1-A3), the function registry further includes capability acquisition information identifying an endpoint that provides the select function as a service. The capability proxy queries the endpoint when executing the select function. The method of A4 is beneficial because it facilitates a call to a web-based software service, effectively providing the function with the requested capability even if the original application developer was unaware of the existence of the web-based software service.

(A5) In yet still another example method of any of the preceding methods (e.g., A1-A4), the execution constraint specifies at least one of function execution cost, function result accuracy, function latency, function power consumption, or function service provider type. (A6) In yet still another example method of any of the preceding methods (e.g., A1-A6), the execution constraint is included in the semantic description received from the application. The methods of A5 and A6 are beneficial because they effectively allow a developer to place a constraint on which function the capability proxy selects from the function registry, based on characteristic(s) that are identified as important to the developer or to an enterprise that owns or makes use of the application.

(A7) In yet still another example method of any of the preceding methods (e.g., A1-A6), the capability proxy includes an enterprise-configurable setting that identifies the execution constraint. For example, different enterprises use different instances of the capability proxy and each different instance has certain settings that are selectively configured by the enterprise, such as to dictate constraints governing the types of functions that the capability proxy selects from the function registry on behalf of various applications of the enterprise.

(A8) In still another example method of any of the preceding methods (e.g., A1-A7), the capability proxy is offered as a web-hosted service.

In another aspect, some implementations include a computing system that includes a capability proxy that identifies and executes functions on behalf of one or more applications, users, or various platforms. The computing system includes hardware logic circuitry that is configured to perform any of the methods described herein (e.g., methods A1-A8).

In yet still another aspect, some implementations include a computer-readable storage medium for storing computer-readable instructions. The computer-readable instructions, when executed by one or more hardware processors, perform any of the methods described herein (e.g., methods A1-A8).

The logical operations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language. The above specification, examples, and data, together with the attached appendices, provide a complete description of the structure and use of example implementations.

What is claimed is:

1. A system comprising:
a capability proxy stored in memory that:
receives a semantic description of a requested function capability;
determines an execution constraint associated with the requested function capability;
queries a function registry based at least in part on the requested function capability;
identifies, based on information returned from the function registry, a select function that provides the requested function capability and that has an execution characteristic satisfying the execution constraint;
executes the select function; and
returns an output of the select function.

2. The system of claim 1, wherein the function registry includes, for each function of a plurality of functions:
a semantic description of function capability; and
a corresponding execution characteristic.

3. The system of claim 1, wherein the function registry further includes an application programming interface (API) syntax usable to invoke each function included in the function registry, and wherein the capability proxy constructs a call to the select function using the API syntax that is specified in the function registry in association with the select function.

4. The system of claim 1, wherein the function registry further includes capability acquisition information identifying an endpoint that provides the select function as a service and wherein the capability proxy queries the endpoint of when executing the select function.

5. The system of claim 1, wherein the execution constraint specifies at least one of function execution cost, function result accuracy, function latency, function power consumption, or function service provider type.

6. The system of claim 1, wherein the execution constraint is included in the semantic description.

7. The system of claim 1, wherein the capability proxy determines the execution constraint based on a configuration file of an application.

8. A method of executing a capability proxy to provide an application with a requested function capability, the method comprising:
receiving, from the application, a semantic description of the requested function capability;
determining an execution constraint associated with the requested function capability;
querying a function registry based at least in part on the requested function capability;
identifying, based on information returned from the function registry, a select function that provides the requested function capability and that has an execution characteristic satisfying the execution constraint;
executing the select function on behalf of the application; and
returning, to the application, an output of the select function.

9. The method of claim 8, wherein the function registry includes, for each function of a plurality of functions:
a semantic description of function capability; and
one or more execution characteristics.

10. The method of claim 8, wherein the function registry further includes an application programming interface (API) syntax usable to invoke each function included in the function registry, and wherein the capability proxy constructs a call to the select function using the API syntax that is specified in the function registry in association with the select function.

11. The method of claim 8, wherein the function registry further includes capability acquisition information identifying an endpoint that provides the select function as a service and wherein the method further includes:
querying the endpoint when executing the select function.

12. The method of claim 8, wherein the execution constraint specifies at least one of function execution cost, function result accuracy, function latency, function power consumption, or function service provider type.

13. The method of claim 8, wherein the execution constraint is included in the semantic description received from the application.

14. The method of claim 8, wherein the capability proxy includes an enterprise-configurable setting that identifies the execution constraint.

15. The method of claim 8, wherein the capability proxy is offered as a web-hosted service.

16. A tangible computer-readable storage media encoding computer-executable instructions for executing a computer process comprising:
receiving, from an application, a semantic description of a requested function capability and an execution constraint;
querying a function registry based at least in part on the requested function capability;
identifying, based on information returned from the function registry, a select function that provides the requested function capability and that has an execution characteristic satisfying the execution constraint;
retrieving, from the function registry, capability acquisition information defining how the select function is invoked;
executing the select function on behalf of the application; and
returning, to the application, an output of the select function.

17. The tangible computer-readable storage media of claim 16, wherein executing the select function further includes calling a call to at least one of a service endpoint or a service discovery endpoint identified within the capability acquisition information.

18. The tangible computer-readable storage media of claim 16, wherein the capability acquisition information indicates a tool usable to generate code to invoke a service and wherein executing the select function further includes using the tool to generate the code to invoke the service.

19. The tangible computer-readable storage media of claim 16, wherein the function registry includes, for each function of a plurality of functions:
a semantic description of function capability; and
an application programming interface (API) syntax usable to invoke each function included in the function registry, and wherein the executing the select function includes constructing a call to the select function using the API syntax that is specified in the function registry in association with the select function.

20. The tangible computer-readable storage media of claim 16, wherein the execution constraint is included in at least one of the semantic description received from the application or a configuration file of the application.
